(19) United States
(12) Patent Application Publication
(10) Pub. No.: US 2021/0180984 A1
(43) Pub. Date: Jun. 17, 2021

(54) METHOD AND SYSTEM FOR GENERATING HIGH DEFINITION MAP

(71) Applicant: WeRide Corp., San Jose, CA (US)

(72) Inventors: Jintao XU, San Jose, CA (US); Qingxiong YANG, San Jose, CA (US); Kit FUNG, San Jose, CA (US); Wanglong WU, San Jose, CA (US); Yan LI, San Jose, CA (US)

(21) Appl. No.: 17/048,609

(22) PCT Filed: Apr. 22, 2019
(86) PCT No.: PCT/US2019/028420

§ 371 Date: Oct. 19, 2020

Related U.S. Application Data
(60) Provisional application No. 62/660,264, filed on Apr. 20, 2018.

(51) Int. Cl. G01C 21/00; G01C 21/32; G01C 21/16; G01C 21/36; G01S 17/89; G01S 7/48

(52) U.S. Cl. CPC G01C 21/3848; G01C 21/32; G01S 7/4808; G01C 21/3694; G01S 17/89; G01C 21/1652

(57) ABSTRACT

Provided is a method of generating high definition maps, which can be used in autonomous driving. The method includes obtaining consecutive mapping data generated by a sensor installed on a vehicle at consecutive positions. The mapping data is used to generate range scan poses and GPS positions of the vehicle at the consecutive positions. The method further includes generating consecutive optimized poses of the vehicle at the consecutive positions according to the range scan poses and the GPS positions of the vehicle. A map is then generated by stitching the consecutive mapping data based on the optimized poses.

### CROSS-REFERENCE TO RELATED APPLICATIONS

The present application claims the benefit of U.S. provisional patent application 62/660,264, filed Apr. 20, 2018, the disclosure of which is incorporated herein by reference in the entirety.

### FIELD OF THE INVENTION

The application generally relates to navigation technology, and more particularly, to methods and systems for generating high definition maps.

### BACKGROUND

Autonomous vehicles need to make real-time decisions on roads. While robots have the capability to do some things more efficiently than humans, the real-time decision-making capability, when it comes to driving and navigation, is one of those key areas that human still have the edge. For example, humans take it for granted to make such decisions as stopping the vehicle at the right place, watching for a traffic signal at the intersection, and avoiding an obstacle on the road in the last minute. These decisions, however, are very difficult for robots to make. As part of the decision-making process for autonomous vehicles, mapping becomes a critical component of helping the robots make the right decisions at the right time.

Autonomous vehicles use high definition (HD) maps that contain a huge amount of driving assistance information. The most important information is the accurate 3-dimensional representation of the road network, such as the layout of the intersection and location of signposts. The HD map also contains a lot of semantic information, such as what the color of traffic lights means, the speed limit of a lane and where a left turn begins. The major difference between the HD map and a traditional map is the precision—while a traditional map typically has a meter-level precision, the HD map requires a centimeter level precision in order to ensure the safety of an autonomous vehicle. Making an HD map with such high precision is still a challenging task. Therefore, there is an urgent need for new methods for making HD maps for autonomous driving.

### SUMMARY OF INVENTION

The present disclosure in one aspect provides a method of generating a high definition map. In one embodiment, the method comprises: obtaining n consecutive mapping data (n is an integer of at least 5), each acquired at one of n consecutive positions, wherein the n consecutive mapping data comprises n consecutive range scan data at the n consecutive positions, and n consecutive GPS positions of the vehicle at the n consecutive positions; generating, based on the n consecutive range scan data, range scan poses of the vehicle; estimating n consecutive poses of the vehicle at the n consecutive positions; calibrating the n consecutive poses using an iterative optimization process having an optimization constraint comprising the range scan poses and the n consecutive GPS positions, thereby generating n consecutive optimized poses of the vehicle at the n consecutive positions; and generating a map by stitching the n consecutive mapping data based on the n consecutive optimized poses.

In one embodiment, the range scan poses are generated by normal distribution transform or iterative closest point (ICP) algorithm.

In one embodiment, the range scan poses comprise (i) relative poses of the vehicle between i-th position and (i−1)-th position, wherein i is an integer between 2 and n; or (ii) relative poses of the vehicle between i-th position and k-th position, wherein i and k are integers between 1 and n, wherein the k-th position is a key position. In certain embodiments, the range scan poses comprise both (i) and (ii).

In certain embodiments, the iterative optimization process is a graph optimization process, ISAM algorithm or CERES algorithm.

In some embodiments, the n consecutive mapping data is generated by a sensor selected from the group consisting of a camera, a LiDAR, a radar, a satellite navigation device, a dead reckoning device, or a combination thereof. In some embodiments, the n consecutive range scan data is generated by a LiDAR. In some embodiments, the n consecutive GPS positions are generated by a satellite navigation device and/or a dead reckoning device. In some embodiments, the satellite navigation device is a GPS receiver, a GLONASS receiver, a Galileo receiver or a BeiDou GNSS receiver. In some embodiments, the satellite navigation device is an RTK satellite navigation device. In some embodiments, the dead reckoning device is an inertial measurement unit (IMU) or an odometry.

In one embodiment, the method of the present disclosure further comprises: obtaining at least a second map generated by stitching m consecutive mapping data based on m consecutive optimized poses at m consecutive positions, wherein the m consecutive optimized poses are generated according to m consecutive range scan data and m consecutive GPS positions, and m being an integer of at least 5; calibrating the n consecutive optimized poses and the m consecutive optimized poses using a second iterative optimization process having a second optimization constraint, thereby generating n consecutive globally optimized poses and m consecutive globally optimized poses; and generating a global map by stitching the first and the second maps based on the n consecutive globally optimized poses and the m consecutive globally optimized poses.

In one embodiment, the second optimization constraint comprises range scan poses generated based on the n consecutive range scan data and the m consecutive range scan data, the n consecutive GPS positions, and the m consecutive GPS positions.

In one embodiment, the range scan poses generated based on the n consecutive range scan data and the m consecutive range scan data comprises: (i) a relative pose of the vehicle between i-th position and (i−1)-th position, wherein i is an integer between 2 and n, wherein the i-th position is one of the n consecutive position; (ii) a relative pose of the vehicle between j-th position and (j−1)-th position, wherein j is an integer between 2 and m, wherein the j-th position is one of the m consecutive position; and (iii) a relative pose of the vehicle between p-th position and q-th position, wherein p is an integer between 1 and n, and q is an integer between 1 and m, wherein the p-th position is one of the n consecutive position, the q-th position is one of the m consecutive position, and distance between the p-th position and the q-th position is within a threshold.

In another aspect, the present disclosure provides a high definition map generated according to the method disclosed herein.

In yet another aspect, the present disclosure provides a navigation device. In one embodiment, the navigation device comprises: a data storage for storing the high definition map disclosed herein; a positioning module for detecting a present position of a vehicle; and a processor configured to receive a destination of the vehicle, and calculate a route for the vehicle based on the high definition map, the present position of the vehicle and the destination of the vehicle.

In one embodiment, the processor is further configured to: receive traffic information associated with the present position of the vehicle; and generate at least one driving control instruction based on the route and the traffic information, wherein the vehicle drives according to the at least one driving control instruction.

In one embodiment, the navigation device further comprises a display for displaying the vehicle and at least a portion of the high definition map data associated with the present position of the vehicle.

In another aspect, the present disclosure provides a system of generating a high definition map. In one embodiment, the system comprises: a vehicle comprising a sensor, a satellite navigation device and/or a dead reckoning device, and a range scan device; a processor; and a memory for storing instructions executable by the processor, wherein the processor is configured to execute steps for generating high definition maps according to a method of the present disclosure.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention. The exemplary embodiments will hereinafter be described in conjunction with the following drawing figures, wherein like numerals denote like elements.

FIG. 1 shows a vehicle installed with equipment to collect mapping data.

FIG. 2 shows an exemplary method for generating range scan poses of a vehicle based on the range scan collected.

FIG. 3 shows an exemplary method for generating range scan poses used as an optimization constraint that comprises relative poses of the vehicle between consecutive positions.

FIG. 4 shows an exemplary method for generating range scan poses used as an optimization constraint that comprises relative poses of the vehicle regarding a key position.

FIG. 5 shows a flow diagram of method for generating a high definition map in accordance with an exemplary embodiment.

FIG. 6 shows a flow diagram of method for generating a global high definition map in accordance with an exemplary embodiment.

### DETAILED DESCRIPTION OF THE INVENTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The present disclosure relates to methods and systems for generating high definition maps, e.g., used in autonomous driving. For the sake of brevity, conventional techniques and components related to the autonomous driving technology and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

As used herein, the singular forms “a”, “an” and “the” include plural references unless the context clearly dictates otherwise.

It is noted that in this disclosure, terms such as “comprises”, “comprised”, “comprising”, “contains”, “containing” and the like have the meaning attributed in United States patent law; they are inclusive or open-ended and do not exclude additional, un-recited elements or method steps. Terms such as “consisting essentially of” and “consists essentially of” have the meaning attributed in United States patent law; they allow for the inclusion of additional ingredients or steps that do not materially affect the basic and novel characteristics of the claimed invention. The terms “consists of” and “consisting of” have the meaning ascribed to them in United States patent law; namely that these terms are close ended.

Methods of Generating a High Definition Map

As an integral part of an autonomous driving system, a high definition map (HD map) is a foundation for high-precision localization, environment perception, planning and decision making, and real-time navigation. An HD map used by an autonomous vehicle contains a huge amount of driving assistance information, including the accurate 3-dimensional representation of the road network, such as the layout of the intersection and location of signposts.

Mapping Data Collection

In order to generate an HD map, raw mapping dataset need to be collected, processed, assembled and edited. In certain embodiments of the present disclosure, the raw mapping datasets are acquired using a combination of sensors installed on a vehicle.

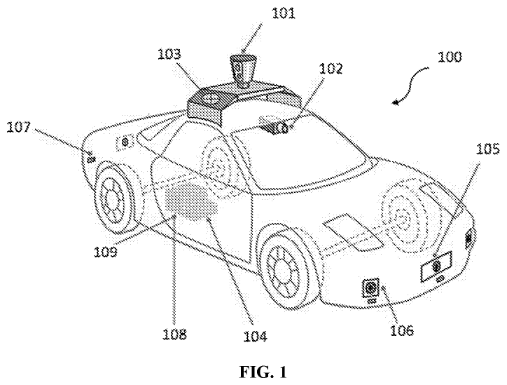

FIG. 1 illustrates an exemplary vehicle that is equipped with devices to collect mapping datasets. Referring to FIG. 1, a vehicle 100 is installed with a LiDAR (light detection and ranging) 101, which uses light beams to densely sample the surface of the objects in the environment. LiDAR is an active optical sensor that transmits laser beams toward a target while moving through specific survey routes. The reflection of the laser from the target is detected and analyzed by receivers in the LiDAR sensor. These receivers record the precise time from when the laser pulse left the system to when it is returned to calculate the range distance between the sensor and the target. Combined with the positional information (e.g. GPS and INS), these distance measurements are transformed to measurements of actual three-dimensional points of the reflective target in object space.

The vehicle 100 is also equipped with a satellite navigation device 103, which locates the vehicle by using satellites to triangulate its position. The satellite navigation devices include, without limitation, GPS receivers, GLONASS receivers, Galileo receivers, BeiDou GNSS receivers and RTK satellite navigation devices.

The vehicle 100 further contains an inertial navigation system (INS) 104 comprising dead reckoning devices, such as inertial measurement units (IMUs) and odometries.

In certain embodiments, the vehicle 100 also contains additional sensors, such as a camera 102, a radar 105, an infrared sensor 106, and an ultrasonic sensor 107. These sensors can be used to collect space information and surrounding information of the vehicle 100 which may be helpful in generating of HD maps.

For the purposes of generating HD maps, the mapping datasets collected include at least two categories: (1) range scan data generated by a range scan device, e.g., a LiDAR; and (2) position/pose data typically generated by satellite navigation devices and/or dead reckoning devices.

After receiving the raw mapping datasets, e.g., the point data collected by LiDAR, a computer or server then processes the mapping datasets into highly accurate georeferenced x, y, z coordinates by analyzing the information collected by the various devices described herein, including the laser time range, laser scan angle, GPS position, and INS information.

Therefore, in one aspect, the present disclosure provides a method for generating high definition maps (HD maps) that are powering self-driving and autonomous vehicles. In certain embodiments, the HD maps generated by the methods disclosed herein have extremely high precision at centimeter-level accuracy (e.g., 1 cm, 2 cm, 3 cm, 4 cm, or 5 cm), which allows autonomous vehicles to produce very precise instructions on how to maneuver themselves and how to navigate around the 3D space.

Range Scan Poses

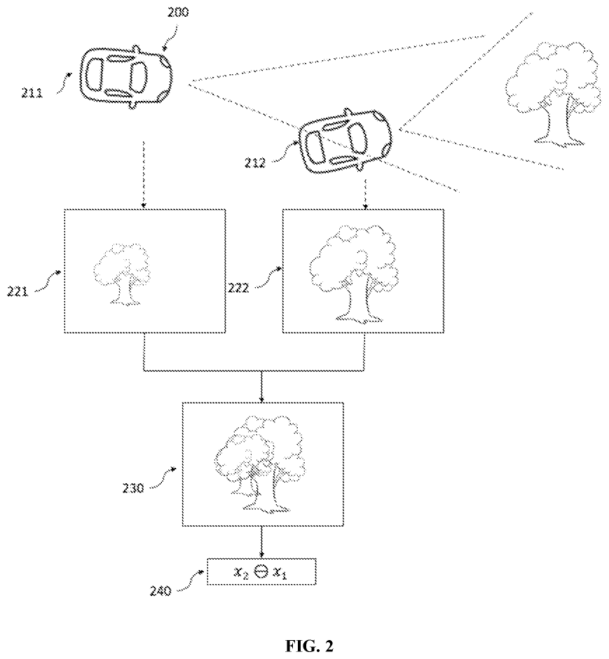

In certain embodiments, the method for generating HD maps disclosed herein involves a step of generating range scan poses of the vehicle based on the range scan collected, which is illustrated in details in FIG. 2. Typically, the range scan poses include the position (i.e., x, y, z coordinates) and the orientation (i.e. heading) of the vehicle. Now referring to FIG. 2, a vehicle 200 equipped with range scan devices (e.g. LiDAR) collected two range scan data 221 and 222 at positions 211 and 212, respectively. The range scan data 221 and 222 has at least overlapping data (e.g. point cloud), illustrated as a tree.

When the two range scan data 221 and 222 are matched based on the overlapping data (see 230), the relative pose of the vehicle (or sensor, i.e., range scan device) 240 (represented as x₂⊖x₁) between the two positions 211 and 212 can be calculated. As used herein, a “relative pose” refers to the vehicle's (or sensor's) pose (position and orientation) at a first location relative to its pose at a second location. The algorithm to calculate (relative) range scan data includes, without limitation, normal distribution transform and iterative closest point algorithm.

Normal distribution transform (NDT) is an algorithm that can be applied for range scan matching (see, e.g., P. Biber, The Normal Distributions Transform: A New Approach to Laser Scan Matching, IEEE (2003); M. Magnusson, The Three-Dimensional Normal-Distributions Transform, dissertation, Orebro University (2009), the disclosure of which is incorporated herein by reference). In general, NDT subdivide the range scan data into cells. A normal distribution is then assigned to each cell, which locally models the probability of measuring a point. The result of the transformation is a piecewise continuous and differentiable probability density, which can be used to match another scan, e.g., using Newton's algorithm.

Iterative closest point (ICP) is an algorithm employed to minimize the difference between two clouds of points. In ICP, one point cloud (vertex cloud), or the reference or target, is kept fixed, while the other one, the source is transformed to best match the reference. The algorithm iteratively revises the transformation (combination of translation and rotation) needed to minimize an error metric, usually a distance from the source to the reference point cloud, such as the sum of squared differences between the coordinates of the matched pairs. ICP is one of the widely used algorithms in aligning three dimensional models given an initial guess of the rigid body transformation required (Rusinkiewics S and Levoy M, Efficient variants of the ICP algorithm, Proceedings Third International Conference on 3-D Digital Imaging and Modeling (2001) 145-152, the disclosure of which is incorporated by reference).

It can be understood that the method described above can be extended to determine the relative pose of the vehicle between a first position and a third position if the relative pose between the first and second positions and the relative pose between the second and third positions are known. Therefore, this method allows to determine the relative pose of the vehicle between two positions by matching the range scan data directly or indirectly, i.e., through matching the intermediate range scan data between the two positions.

If the pose of the vehicle at the position 311 is known, the pose of the vehicle at the position 312 can be determined based on the relative pose 340. Therefore, the method disclosed above can be used to estimate the pose of the vehicle, either in relative form or absolute form. Therefore, as used herein, range scan poses include both relative poses and absolute poses.

Iterative Optimization Process

In certain embodiments, the method disclosed herein involves a step of optimization or calibration using an iterative optimization process. In certain embodiments, the iterative optimization process has an optimization constraint comprising range scan poses and/or GPS positions.

In certain embodiments, the range scan poses used as an optimization constraint comprise: (i) relative poses of the vehicle between i-th position and (i−1)-th position, wherein i is an integer between 2 and n; (ii) relative poses of the vehicle between i-th position and k-th position, wherein i and k are integers between 1 and n, wherein the k-th position is a key position; or both (i) and (ii).

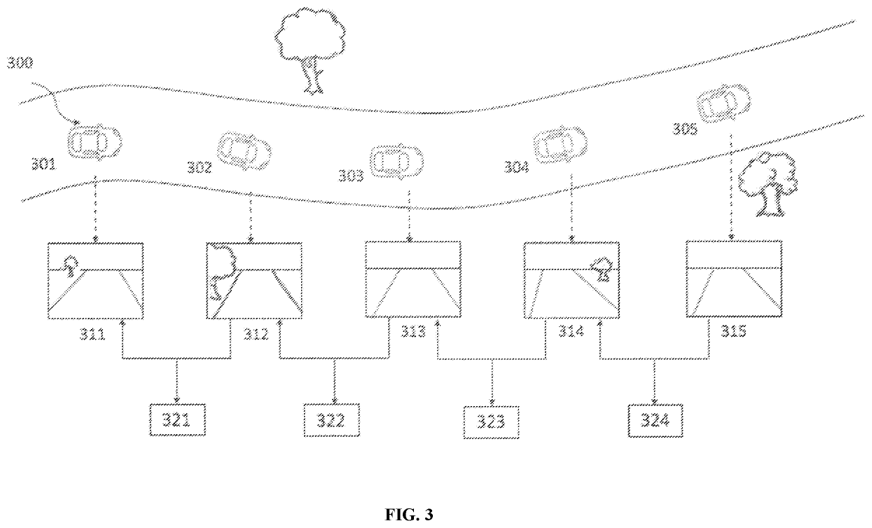

FIG. 3 illustrates an embodiment in which the range scan poses used as an optimization constraint comprise relative poses of the vehicle between i-th position and (i−1)-th position, wherein i is an integer between 2 and n. For simplicity, only five positions are shown. Now referring to FIG. 3, a vehicle 300 generates at five consecutive positions 301-305 along the road five range scan data 311-315. A relative range scan pose 321 of the vehicle between position 302 and position 301 is calculated by matching the range scan data 312 and range scan data 311. Similarly, relative range scan poses 322, 323, 324 between positions 303 and 302, between positions 304 and 303, and between positions 305 and 304 are calculated, respectively, by matching each pair of consecutive range scan data. The iterative optimization process then calibrates the poses using an optimization constraint including the relative poses of the vehicle between each pair of consecutive range scan data.

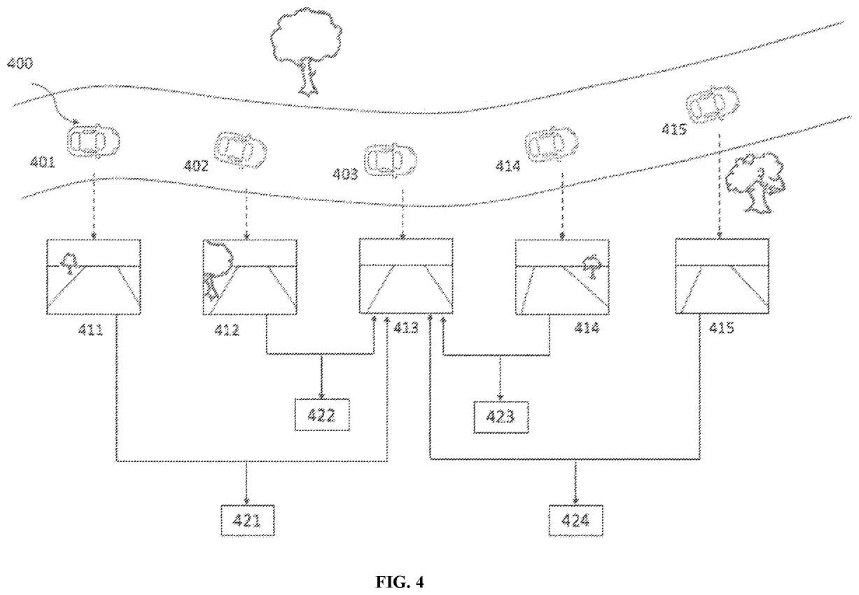

FIG. 4 illustrates an embodiment in which the range scan poses used as an optimization constraint comprise relative poses of the vehicle between i-th position and k-th position, wherein i and k are integers between 1 and n, wherein the k-th position is a key position. For simplicity, only five positions are shown. Now referring to FIG. 4, a vehicle 400 generates at five positions 401-405 along the road five range scan data 411-415. Position 403 is selected as a key position. Typically, a key position is selected because the GPS data or the range scan data is good and reliable in this position. A relative range scan pose 421 of the vehicle between position 401 and position 403 is calculated by matching the range scan data 411 and range scan data 413. Similarly, relative range scan poses 422, 423, 424 between positions 402 and 403, between positions 404 and 403, and between positions 405 and 403 are calculated, respectively, by matching each pair of range scan data. The iterative optimization process then calibrates the poses using an optimization constraint including the relative poses of the vehicle calculated.

In certain embodiments, the iterative optimization process has an optimization constraint comprising GPS positions. As used herein, “GPS positions” refer to positions calculated based on the position/pose data generated by satellite navigation devices and/or dead reckoning devices. Typically, the GPS position is refined by combining the satellite navigation devices and dead reckoning devices.

In certain embodiments, the iterative optimization process is a graph optimization process, iSAM algorithm or CERES algorithm. See, e.g., R. Kummerle et al., g² o: A General Framework for Graph Optimization, IEEE (2011); Kaess M et al, iSAM: Incremental smoothing and mapping, IEEE (2008) Transaction on Robotics, manuscript, the disclosure of which is incorporated herein by reference.

In certain embodiments, the iterative optimization process has an optimization constraint comprising both range scan poses and GPS positions. In one example, the iterative optimization process comprises an objective function of F(x)=F^{r}(x)+F^{g}(x) and x*=argminₓ(F(x)), wherein x represents a virtual measurement of poses, x* represents the n consecutive optimized poses, F^{r}(x) represents the function having an optimization constraint of range scan poses, and F^{g}(x) represents the function having an optimization constraint of GPS position.

In certain embodiments, F^{r}(x)=Fⁿ(x), wherein

Fⁿ(x)=Σᵢ₌₂ⁿ(eᵥ_{ᵢ}_{,v}_{ᵢ₋₁}(xᵥ_{ᵢ},xᵥ_{ᵢ₋₁}))^{T}Ωᵥ_{ᵢ}_{,v}_{ᵢ₋₁}eᵥ_{ᵢ}_{,v}_{ᵢ₋₁}(xᵥ_{ᵢ},xᵥ_{ᵢ₋₁}),

wherein the error function

eᵥ_{ᵢ}_{,v}_{ᵢ₋₁}(xᵥ_{ᵢ},xᵥ_{ᵢ₋₁})≐zᵥ_{ᵢ}_{,v}_{ᵢ₋₁}⊖hᵥ_{ᵢ}_{,v}_{ᵢ₋₁}(xᵥ_{ᵢ},xᵥ_{ᵢ₋₁})

zᵥ_{ᵢ}_{,v}_{ᵢ₋₁}≐xᵥ_{ᵢ}^{rs}⊖xᵥ_{ᵢ₋₁}^{rs}

hᵥ_{ᵢ}_{,v}_{ᵢ₋₁}(xᵥ_{ᵢ},xᵥ_{ᵢ₋₁})≐xᵥ_{ᵢ}⊖xᵥ_{ᵢ₋₁}

wherein xᵥ_{ᵢ}^{rs} denotes range scan pose, zᵥ_{ᵢ}_{,v}_{ᵢ₋₁} denotes the relative pose of two consecutive range scan poses. hᵥ_{ᵢ}_{,v}_{ᵢ₋₁}(xᵥ_{ᵢ}, xᵥ_{ᵢ₋₁}) is the relative pose of a measurement prediction function that computes a virtual measurement xᵥ, which is optimized through the process. In certain embodiment, the initial guess of xᵥ is estimated based on the position/pose data generated by satellite navigation devices and/or dead reckoning devices.

Ωᵥ_{ᵢ}_{,v}_{ᵢ₋₁}∈R^{4×4} represents the inverse covariance of the mapping data (i.e., measurements), and thus are symmetric and positive definite.

In certain embodiments, F^{r}(x)=F^{k}(X), wherein

F^{k}(X)=Σᵢ₌₁ⁿ(eᵥ_{ᵢ}_{,v}_{ᵢ}_{^{k}}(xᵥ_{ᵢ},xᵥ_{ᵢ}_{^{k}}))^{T}Ωᵥ_{ᵢ}_{,v}_{ᵢ}_{^{k}}eᵥ_{ᵢ}_{,v}_{ᵢ}_{^{k}}(xᵥ_{ᵢ},xᵥ_{ᵢ}_{^{k}}),

wherein the error function

eᵥ_{ᵢ}_{,v}_{ᵢ}_{^{k}}(xᵥ_{ᵢ},xᵥ_{ᵢ}_{,v}_{ᵢ}_{^{k}})≐zᵥ_{ᵢ}_{,v}_{ᵢ}_{^{k}}⊖hᵥ_{ᵢ}_{,v}_{ᵢ}_{^{k}}(xᵥ_{ᵢ},xᵥ_{ᵢ}_{^{k}})

zᵥ_{ᵢ}_{,v}_{ᵢ}_{^{k}}≐xᵥ_{ᵢ}^{rs}⊖x_{,v}_{ᵢ}_{^{k}}^{rs}

hᵥ_{ᵢ}_{,v}_{ᵢ}_{^{k}}(xᵥ_{ᵢ},xᵥ_{ᵢ}_{^{k}})≐xᵥ_{ᵢ}⊖xᵥ_{ᵢ}_{^{k}}

wherein xᵥ_{ᵢ}^{rs} denotes range scan pose, denotes the relative pose of the vehicle between a position and a key position. hᵥ_{ᵢ}_{,v}_{ᵢ}_{^{k}}(xᵥ_{ᵢ}, xᵥ_{ᵢ}_{^{k}}) is the relative pose of a measurement prediction function that computes a virtual measurement xᵥ, which is optimized through the process. In certain embodiment, the initial guess of xᵥ is estimated based on the position/pose data generated by satellite navigation devices and/or dead reckoning devices.

Ωᵥ_{ᵢ}_{,v}_{ᵢ}_{^{k}}∈R^{4×4} represent the inverse covariance of the mapping data (i.e., measurements), and thus are symmetric and positive definite.

In certain embodiments,

F^{g}(x)=Σᵢ₌₁ⁿ(eᵥ_{ᵢ}_{,v}_{ᵢ}_{^{g}}^{g}(xᵥ_{ᵢ},xᵥ_{ᵢ}_{^{g}}^{g}))^{T}Ωᵥ_{ᵢ}_{,v}_{ᵢ}_{^{g}}eᵥ_{ᵢ}_{,v}_{ᵢ}_{^{g}}^{g}(xᵥ_{ᵢ},xᵥ_{ᵢ}_{^{g}}^{g}),

wherein position error function,

eᵥ_{ᵢ}_{,v}_{ᵢ}_{^{g}}^{g}(xᵥ_{ᵢ},xᵥ_{ᵢ}_{^{g}}^{g})≐xᵥ_{ᵢ}^{g}⊖xᵥ_{ᵢ}_{^{g}}^{g}

wherein xᵥ_{ᵢ}^{g} denotes the position (x, y, z coordinance) of vehicle pose xᵥ_{ᵢ}, and xᵥ_{ᵢ}_{^{g}}^{g} is the GPS position of the vehicle (vertex vᵢ).

Ωᵥ_{ᵢ}_{,v}_{ᵢ}_{^{g}}∈R^{3×3} represents the inverse covariance of the mapping data (i.e., measurements), and thus are symmetric and positive definite.

In certain embodiments, the iterative optimization process has an optimization constraint comprising both range scan poses and GPS positions, wherein the range scan poses include both the relative pose of consecutive range scan poses and the relative poses regarding key positions. In one example, the iterative optimization process comprises an objective function of F(x)=Fⁿ(x)+F^{k}(x)+F^{g}(x) and x*=argminₓ(F(x)), wherein

Fⁿ(x)=Σᵢ₌₂ⁿ(eᵥ_{ᵢ}_{,v}_{ᵢ₋₁}(xᵥ_{ᵢ},xᵥ_{ᵢ₋₁}))^{T}Ωᵥ_{ᵢ}_{,v}_{ᵢ₋₁}eᵥ_{ᵢ}_{,v}_{ᵢ₋₁}(xᵥ_{ᵢ},xᵥ_{ᵢ₋₁}),

F^{k}(x)=Σᵢ₋₁ⁿ(eᵥ_{ᵢ}_{,v}_{ᵢ}_{^{k}}(xᵥ_{ᵢ},xᵥ_{ᵢ}_{^{k}}))^{T}Ωᵥ_{ᵢ}_{,v}_{ᵢ}_{^{k}}eᵥ_{ᵢ}_{,v}_{ᵢ}_{^{k}}(xᵥ_{ᵢ},xᵥ_{ₖ}_{^{k}}),

F^{g}(x)=Σᵢ₌₁ⁿ(eᵥ_{ᵢ}_{,v}_{ᵢ}_{^{g}}^{g}(xᵥ_{ᵢ},xᵥ_{ᵢ}_{^{g}}^{g}))^{T}Ωᵥ_{ᵢ}_{,v}_{ᵢ}_{^{g}}eᵥ_{ᵢ}_{,v}_{ᵢ}_{^{g}}^{g}(xᵥ_{ᵢ},xᵥ_{ᵢ}_{^{g}}^{g}).

Map Generation

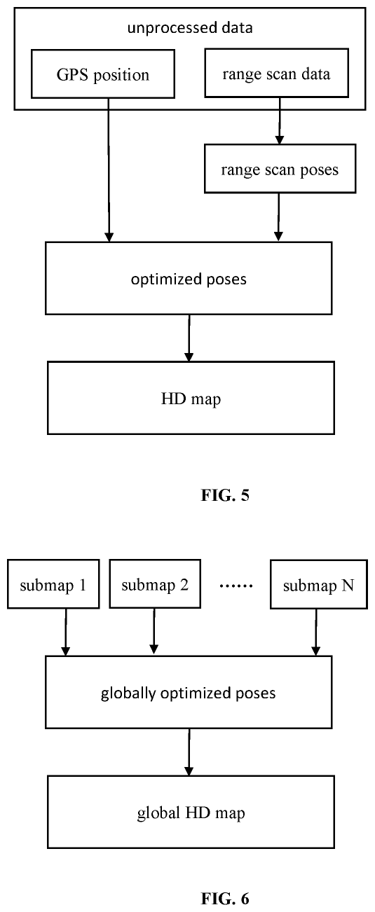

FIG. 5 illustrates a flow diagram of method for generating HD maps according to one exemplary embodiment. Referring to FIG. 5, the method includes a step of obtaining datasets required for generating the HD map. The datasets are typically acquired using a combination of sensors installed on a vehicle, such as the vehicle 100 shown in FIG. 1. The combination of the sensors includes, for example, cameras, LiDAR, radars, satellite navigation devices, and dead reckoning devices. The satellite navigation devices include, without limitation, GPS receivers, GLONASS receivers, Galileo receivers, BeiDou GNSS receivers and RTK satellite navigation devices. The dead reckoning devices include, without limitation, inertial measurement units (IMUs) and odometries.

For the purposes of generating HD maps, the datasets used in the method of the present disclosure include two categories of data: range scan data generated by a range scan device, e.g., a LiDAR; and position/pose data typically generated by satellite navigation devices and/or dead reckoning devices. The sensors generate the data at consecutive positions when the vehicle is moving around an area. Consecutive positions herein refers to positions in a path or trajectory along which the vehicle is moving and neighboring to each other when viewed in the path (see FIG. 3 for illustration). Consequently, the data is called consecutive as each of them is generated when the vehicle (i.e., the sensor) is at one of the consecutive positions. It is understood that different sensors may generate data at different frequency. For example, a LiDAR may generate range scan data at a frequency of 5 Hz (i.e., 5 scans per second) while GPS receivers may generate position data at a much higher frequency. However, operations can be carried out to adjust the sensors or the data such that the consecutive data generated by different sensors and used in making the HD map are matched, i.e., generated at the same consecutive positions.

With reference to FIG. 5, the exemplary method further includes a step of generating range scan poses of the vehicle based on the range scan data.

With reference to FIG. 5, the exemplary method further includes a step of generating consecutive optimized poses of the vehicle at the consecutive positions by calibrating estimated consecutive poses using an iterative optimization process having an optimization constraint comprising the range scan poses and the n consecutive GPS positions.

In one embodiment, when there are n consecutive mapping data generated at n consecutive positions, the range scan poses comprise (i) relative poses of the vehicle between i-th position and (i−1)-th position, wherein i is an integer between 2 and n; (ii) relative poses of the vehicle between i-th position and k-th position, wherein i and k are integers between 1 and n, wherein the k-th position is a key position; or both (i) and (ii).

In certain embodiments, there are a series of key positions in the consecutive positions. The distance between two closest key positions is about 10 to 30 meters.

With reference to FIG. 5, after generating the optimized poses, the method further includes a step of making a HD map by stitching the consecutive mapping data according to the optimized poses. The term “stitch,” when used in the context of mapping data processing, refers to a process of combining two or more overlapping images (e.g., point clouds from range scan data) to generate a map. The method of stitching mapping data (images) into a map is known in the art, e.g., see R. Kummerle et al., g² o: A General Framework for Graph Optimization, IEEE (2011) and references therein).

In some embodiments, the method described above can handle mapping data generated at about 100, 200, 300, 400, 500, 600, 700, 800, 900, 1000, 1100, 1200, 1300, 1400, 1500, 1600, 1700, 1800, 1900, 2000 positions. In one embodiment, the method described above handles mapping data generated at about 1000-1500 positions.

Global Map Generation

Depending on the computation power and/or the mapping data obtained, the method disclosed in the previous section may be more suitable for generating a local map (e.g., 100 m, 200 m, 300 m, 400 m, 500 m, 600 m, 700 m, 800 m, 900 m, 1000 m in distance). The local map can be further used to generate a global map (more than 1 km, 2 km, 3 km, 4 km, 5 km, 6 km, 7 km, 8 km, 9 km, 10 km, 20 km, 30 km, 40 km, 50 km, 100 km, 200 km in distance). Therefore, in another aspect, the present disclosure provides a method of combining local maps to generate a global map. FIG. 6 illustrates a flow diagram of the method for generating global maps.

With reference to FIG. 6, the exemplary method includes a step of obtaining a number of local map (submap) generated using the method disclosed in the previous section. In one example, the method obtaining at least a first submap and a second submap. The first submap is generated by stitching n consecutive mapping data (n is an integer of at least 5, e.g., 6, 7, 8, 9, 10, 11, 12, 13, 14, 15, 16, 17, 18, 19, 20, 25, 30, 35, 40 etc) based on n consecutive optimized poses at n consecutive positions, wherein the n consecutive optimized poses are generated according to range scan poses generated based on n consecutive range scan data and n consecutive GPS positions. The second submap is generated by stitching m consecutive mapping data (m is an integer of at least 5) based on m consecutive optimized poses at m consecutive positions, wherein the m consecutive optimized poses are generated according to range scan poses generated based on m consecutive rang scan data and m consecutive GPS positions.

The exemplary method further includes a step of generating n consecutive globally optimized poses and m consecutive globally optimized poses by calibrating the n consecutive optimized poses and the m consecutive optimized poses using a second iterative optimization process having a second optimization constraint comprising:
range scan poses generated based on the n consecutive range scan data and the m consecutive range scan data,
the n consecutive GPS positions, and
the m consecutive GPS positions,
thereby generating n consecutive globally optimized poses and m consecutive globally optimized poses.

In certain embodiments, the range scan poses generated based on the n consecutive range scan data and the m consecutive range scan data comprises: (i) a relative pose of the vehicle between i-th position and (i−1)-th position, wherein i is an integer between 2 and n, wherein the i-th position is one of the n consecutive position; (ii) a relative pose of the vehicle between j-th position and (j−1)-th position, wherein j is an integer between 2 and m, wherein the j-th position is one of the m consecutive position; and (iii) a relative pose of the vehicle between p-th position and q-th position, wherein p is an integer between 1 and n, and q is an integer between 1 and m, wherein the p-th position is one of the n consecutive position, the q-th position is one of the m consecutive position, and distance between the p-th position and the q-th position is within a threshold.

In one example, the iterative optimization process comprises an objective function of F(x)=F^{e}(x)+Fⁱ(x)+F^{g}(x) and x*=argminₓ(F(x)), wherein

$${F}^{e} ( x ) = {\sum }_{{s}_{k} , {s}_{l} ∈ C} {\sum }_{{v}_{i} ∈ {s}_{k} , {v}_{j} ∈ {s}_{l}} {( {e}_{{v}_{i} , {v}_{j}} ( {x}_{{v}_{i} ,} {x}_{{v}_{j}} ) )}^{T} {Ω}_{{v}_{i} , {v}_{j}} {e}_{{v}_{i} , {v}_{j}} ( {x}_{{v}_{i} ,} {x}_{{v}_{j}} )$$

$${F}^{i} ( x ) = {\sum }_{{s}_{k} ∈ C} {\sum }_{{v}_{i} , {v}_{i - 1} ∈ {s}_{k}} {( {e}_{{v}_{i} , {v}_{i - 1}} ( {x}_{{v}_{i} ,} {x}_{{v}_{i - 1}} ) )}^{T} {Ω}_{{v}_{i} , {v}_{i - 1}} {e}_{{v}_{i} , {v}_{i - 1}} ( {x}_{{v}_{i}} {x}_{{v}_{i - 1}} ) , \\ {F}^{g} ( x ) = {\sum }_{{s}_{k} ∈ C} {\sum }_{{v}_{i} ∈ {s}_{k}} {( {e}_{{v}_{i} , {v}_{i}^{g}}^{g} ( {x}_{{v}_{i} ,} {x}_{{v}_{i}^{g}}^{g} ) )}^{T} {Ω}_{{v}_{i} , {v}_{i}^{g}} {e}_{{v}_{i} , {v}_{i}^{g}}^{g} ( {x}_{{v}_{i} ,} {x}_{{v}_{i}^{g}}^{g} ) ,$$

wherein sₗ≠sₖ and vⱼ∈N(vᵢ). If distance between vⱼ and vᵢ is below a threshold, then vⱼ is in the neighborhood of vᵢ(N(vᵢ)). C denotes the submap set.

In some embodiments, the threshold is about 10, 20, 30, 40, 50, 60, 70, 80, 90, 100, 110, 120, 130, 140, 150, 160, 170, 180, 190, 200, 250, 300, 350, 400, 450, 500, 550, 600, 650, 700, 750, 800, 850, 900, or 1000 meters.

With reference to FIG. 5, after generating the optimized poses, the method further includes a step of making a global map by stitching the submaps based on the globally optimized poses.

Devices and Systems

The HD maps generated by the methods disclosed herein can be used in autonomous vehicles. Therefore, in another aspect, the present disclosure provides a navigation device. In one embodiment, the navigation device comprises: a data storage for storing the high definition map disclosed herein; a positioning module for detecting a present position of a vehicle; and a processor configured to receive a destination of the vehicle and calculate a route for the vehicle based on the HD map, the present position of the vehicle and the destination of the vehicle.

In one embodiment, the processor is further configured to: receive traffic information associated with the present position of the vehicle; and generate at least one driving control instruction based on the route and the traffic information, wherein the vehicle drives according to the at least one driving control instruction.

In one embodiment, the navigation device further comprises a display for displaying the vehicle and at least a portion of the high definition map data associated with the present position of the vehicle.

In another aspect, the present disclosure provides a system of generating HD maps. In one embodiment, the system comprises: a vehicle comprising a sensor, a satellite navigation device and/or a dead reckoning device, and a range scan device; a processor; and a memory for storing instructions executable by the processor, wherein the processor is configured to execute steps for generating high definition maps according to the method of the present disclosure.

As used herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

1. A method of generating a high definition map, the method comprising:
obtaining n consecutive mapping data, each generated at one of n consecutive positions of a vehicle, n being an integer of at least 5, wherein the n consecutive mapping data comprises:
n consecutive range scan data at the n consecutive positions, and
n consecutive GPS positions of the vehicle at the n consecutive positions;
generating, based on the n consecutive range scan data, range scan poses of the vehicle;
estimating n consecutive poses of the vehicle at the n consecutive positions;
calibrating the n consecutive poses using an iterative optimization process having an optimization constraint comprising the range scan poses and the n consecutive GPS positions, thereby generating n consecutive optimized poses of the vehicle at the n consecutive positions; and
generating a first map by stitching the n consecutive mapping data based on the n consecutive optimized poses.

2. The method of claim 1, wherein the range scan poses are generated by normal distribution transform or iterative closest point algorithm.

3. The method of claim 1, wherein the range scan poses comprise
(i) relative poses of the vehicle between i-th position and (i−1)-th position, wherein i is an integer between 2 and n; or
(ii) relative poses of the vehicle between i-th position and k-th position, wherein i and k are integers between 1 and n, wherein the k-th position is a key position.

4. The method of claim 3, wherein the range scan poses comprise both (i) and (ii).

5. The method of claim 1, wherein the iterative optimization process is a graph optimization process, ISAM algorithm or CERES algorithm.

6. The method of claim 1, wherein the n consecutive poses of the vehicle are estimated based on data generated by a satellite navigation device and/or a dead reckoning device.

7. The method of claim 1, wherein the n consecutive mapping data is generated by a sensor selected from the group consisting of a camera, a LiDAR, a radar, a satellite navigation device, a dead reckoning device, or a combination thereof.

8. The method of claim 1, wherein the n consecutive range scan data is generated by a LiDAR.

9. The method of claim 1, wherein the n consecutive GPS positions are generated by a satellite navigation device and/or a dead reckoning device.

10. The method of claim 9, wherein the satellite navigation device is a GPS receiver, a GLONASS receiver, a Galileo receiver, a BeiDou GNSS receiver or an RTK satellite navigation device.

11. The method of claim 9, wherein the dead reckoning device is an inertial measurement unit (IMU) or an odometry.

12. The method of claim 1, further comprising:
obtaining at least a second map generated by stitching m consecutive mapping data based on m consecutive optimized poses at m consecutive positions, wherein the m consecutive optimized poses are generated according to m consecutive range scan data and m consecutive GPS positions, and m being an integer of at least 5;
calibrating the n consecutive optimized poses and the m consecutive optimized poses using a second iterative optimization process having a second optimization constraint comprising:
range scan poses generated based on the n consecutive range scan data and the m consecutive range scan data,
the n consecutive GPS positions, and
the m consecutive GPS positions,
thereby generating n consecutive globally optimized poses and m consecutive globally optimized poses; and
generating a global map by stitching the first and the second maps based on the n consecutive globally optimized poses and the m consecutive globally optimized poses.

13. The method of claim 12, wherein the range scan poses generated based on the n consecutive range scan data and the m consecutive range scan data comprises:
(i) a relative pose of the vehicle between i-th position and (i−1)-th position, wherein i is an integer between 2 and n, wherein the i-th position is one of the n consecutive position;
(ii) a relative pose of the vehicle between j-th position and (j−1)-th position, wherein j is an integer between 2 and m, wherein the j-th position is one of the m consecutive position; and
(iii) a relative pose of the vehicle between p-th position and q-th position, wherein p is an integer between 1 and n, and q is an integer between 1 and m, wherein
the p-th position is one of the n consecutive position,
the q-th position is one of the m consecutive position, and
distance between the p-th position and the q-th position is within a threshold.

14. (canceled)

15. A high definition map generated according to a method comprising:
obtaining n consecutive mapping data, each generated at one of n consecutive positions of a vehicle, n being an integer of at least 5, wherein the n consecutive mapping data comprises:
n consecutive range scan data at the n consecutive positions, and
n consecutive GPS positions of the vehicle at the n consecutive positions;
generating, based on the n consecutive range scan data, range scan poses of the vehicle;
estimating n consecutive poses of the vehicle at the n consecutive positions;
calibrating the n consecutive poses using an iterative optimization process having an optimization constraint comprising the range scan poses and the n consecutive GPS positions, thereby generating n consecutive optimized poses of the vehicle at the n consecutive positions; and
generating the map by stitching the n consecutive mapping data based on the n consecutive optimized poses.

16. A navigation device, comprising:
a data storage for storing the high definition map of claim 15;
a positioning module for detecting a present position of a vehicle; and
a processor configured to
receive a destination of the vehicle, and
calculate a route for the vehicle based on the high definition map, the present position of the vehicle and the destination of the vehicle.

17. The navigation device of claim 16, wherein the processor is further configured to:
receive traffic information associated with the present position of the vehicle; and
generate at least one driving control instruction based on the route and the traffic information, wherein the vehicle drives according to the at least one driving control instruction.

18. The navigation device of claim 16, further comprising a display for displaying the vehicle and at least a portion of the high definition map data associated with the present position of the vehicle.

19. A system of generating a high definition map, comprising:
a vehicle comprising
a sensor,
a satellite navigation device and/or a dead reckoning device, and
a range scan device;
a processor; and
a memory for storing instructions executable by the processor,
wherein the processor is configured to execute steps comprising:
obtaining n consecutive mapping data, each generated at one of n consecutive positions of a vehicle, n being an integer of at least 5, wherein the n consecutive mapping data comprises:
n consecutive range scan data at the n consecutive positions, and
n consecutive GPS positions of the vehicle at the n consecutive positions;
generating, based on the n consecutive range scan data, range scan poses of the vehicle;
estimating n consecutive poses of the vehicle at the n consecutive positions;
calibrating the n consecutive poses using an iterative optimization process having an optimization constraint comprising the range scan poses and the n consecutive GPS positions, thereby generating n consecutive optimized poses of the vehicle at the n consecutive positions; and
generating a first map by stitching the n consecutive mapping data based on the n consecutive optimized poses.

20. The system of claim 19, wherein the processor is configured to further execute steps comprising:
obtaining at least a second map generated by stitching m consecutive mapping data based on m consecutive optimized poses at m consecutive positions, wherein the m consecutive optimized poses are generated according to m consecutive range scan data and m consecutive GPS positions, and m being an integer of at least 5;
calibrating the n consecutive optimized poses and the m consecutive optimized poses using a second iterative optimization process having a second optimization constraint comprising:
range scan poses generated based on the n consecutive range scan data and the m consecutive range scan data,
the n consecutive GPS positions, and
the m consecutive GPS positions,
thereby generating n consecutive globally optimized poses and m consecutive globally optimized poses; and
generating a global map by stitching the first and the second maps based on the n consecutive globally optimized poses and the m consecutive globally optimized poses.
